(19) United States
(12) Patent Application Publication
(10) Pub. No.: US 2009/0008324 A1
(43) Pub. Date: Jan. 8, 2009

(54) INTERMITTENT ANAEROBIC BIOLOGICAL TREATMENTS OF RAINFALL-INDUCED SEWERAGE

(76) Inventors: Dennis J. Long, Cleveland, OH (US); Jeffrey M. Lauria, Delaware, OH (US)

Correspondence Address: DUANE MORRIS LLP - Philadelphia;IP DEPARTMENT, 30 SOUTH 17TH STREET, PHILADELPHIA, PA, 19103-4196, US

(21) Appl. No.: 12/061,330

(22) Filed: Apr. 2, 2008

Related U.S. Application Data
(63) Continuation-in-part of application No. 11/112,214, filed on Apr. 22, 2005, now abandoned.
(60) Provisional application No. 60/565,893, filed on Apr. 28, 2004.

(51) Int. Cl. C02F 3/30

(52) U.S. Cl. 210/605

(57) ABSTRACT

The present invention relates to the application of the biological adsorption and biological oxidation ability of both conventional wastewater treatment biological selection technology and, if desired, chemically-enhanced wastewater treatment biological selection technology to remove pollutants from precipitation-generated flows collected by a combined sanitary sewer system, a separate sanitary sewer system, and/or a combination of both systems for: (1) the biological adsorption and oxidation of suspended and dissolved pollutants as measured by standard methods tests for carbonaceous biochemical oxygen demand, and/or (2) the biological adsorption of all other dissolved non-conservative and conservative pollutants as measured by all other standard methods tests for such pollutants.

### CROSS REFERENCE TO RELATED APPLICATIONS

This application is a continuation-in-part of application Ser. No. 11/112,214 filed Apr. 22, 2005, which claims priority to U.S. Provisional Patent Application No. 60/565,893, filed Apr. 28, 2004.

### BACKGROUND OF THE INVENTION

Generally accepted wastewater management methods include the steps of collecting wastewater in a centralized system of pipes and channels, transporting it via these pipes and channels to a treatment facility, treating it at the treatment facility, discharging the treated effluent into natural bodies of water or on land, or reusing it for water supplies.

Wastewater treatment systems are complex, demanding and expensive to build and operate. Improvements to wastewater treatment facilities are an ongoing, essentially regulatory-driven process as a result of both continuous operation and maintenance needs and the periodic imposition of new regulatory drivers such as but not limited to new regulations, new rules and new policies. However, improvements to wastewater treatment plants, while frequently made separate from improvements to centralized systems, have been routinely unable to be made large enough to sufficiently treat either all flows actually collected and transported by a centralized system or all flows that should be collected and transported in order to provide the necessary protection of the environment. This is a result of the overriding need to constantly maintain the reliable operation of wastewater treatment plants within operating parameters established by the state-of-the-art for the technologies that have been available for the design of a wastewater treatment plant. This “peak flow treatment” shortcoming in technologies for the design of a wastewater treatment plant frequently limits the ability of the collection and transportation functions of a centralized system, resulting in the discharge of untreated or inadequately treated wastewater to the environment. These discharges are called combined sewer overflows (CSOs) when the centralized system is a system designed and constructed to convey both sanitary sewage and storm drainage in the same pipes and channels. Alternatively, these discharges are called separate sewer overflows (SSOs) when the centralized system is a system designed and constructed to convey sanitary sewage in one set of pipes and channels and storm drainage in another set of pipes and channels generally adjacent to the portion of the centralized system conveying sanitary sewage.

Anaerobic treatment of wastewater and wastewater biological solids is well known as accepted practice, as is both aerobic treatment technology for wastewater and wastewater biological solids and chemically enhanced aerobic treatment technology for wastewater and wastewater biological solids by addition of chemicals such as but not limited to ferric chloride, sodium acetate and alum. Resulting from wastewater treatment, wastewater biological solids are commonly referred to as sludge and are referred herein as sludge. In the past, this technology was used mainly for both: 1) digestion of sludge, since sludge contains constantly varying amounts of pathogenic biological solids as well as constantly varying amounts of inert solids and chemical solids; and 2) simplified treatment of small wastewater streams in septic tanks generally located in land uses not served by a centralized system of pipes and channels. Recently, anaerobic methods have been applied to treat larger flows of more concentrated industrial wastewater, primarily in the food and beverage industries, and to sludge conditioning and/or nutrient removal during dry weather flow conditions ahead of aerobic treatment technology at municipal wastewater treatment plants. These more recent applications have revealed the general advantages and disadvantages of anaerobic treatment methods. Additionally, fundamental research has been conducted on the anaerobic treatment of more complex wastewater, including both industrial wastewater samples and imitations thereof with poorly degradable and/or toxic organics.

Coupled anaerobic-aerobic systems are also known in accepted practice as systems incorporating a separate anaerobic subsystem (the functional subsystem) followed by an aerobic subsystem (a second functional subsystem and/or a support system). This coupled system has important advantages as compared to solely aerobic systems. The coupled system has been shown to be able to treat a higher concentration waste and to be able to achieve a better removal of soluble and suspended solid organics.

Several modifications of biofiltration systems have also been developed, including aerobic and anaerobic, with and without water recirculation, a single or multiple-stage system. Various lagoon systems have also been developed. Most often the lagoon systems comprise a series of aerated or nonaerated sections. Hydraulic retention time in lagoons is long and sludge recycle is not practiced. Processes in lagoons are usually similar to those in anaerobic sludge processes (ASP), but are not intensive and are less controlled. Some lagoons may have an anaerobic section, often followed with an aerobic section. Open anaerobic lagoons can produce odors. Large water volume in the systems promotes equalization of wastewater and sludge concentrations and provides substantial process stability. However, inadequate mixing sometimes causes breakthroughs of inadequately treated waste, and resulting overall low process efficiency. These systems are mechanically simple, with low maintenance and generally require significantly more surface area for the treatment processes.

Sludge generated in the wet stream of a wastewater treatment plant is routinely directed to the solids stream of the plant. Usually, the solids stream processes include aerobic biological stabilization processes, anaerobic biological stabilization processes or chemical stabilization processes for destroying pathogens contained in the sludge. Sludge thickening may precede biological stabilization. Methods of sludge thickening include but are not limited to the following: gravity thickening in tanks designed as settling tanks, possibly equipped with gentle mixing; dissolved air flotation; gravity thickening belt filters; drum screens; and centrifuges.

During biological stabilization, sludge is substantially mineralized and becomes nonrotting; however, it retains a large proportion of water, which can make sludge disposal difficult and much more costly. Accordingly, sludge is usually dewatered and dried, prior to disposal. While dewatering using drying beds is the method typically preferred at smaller plants, separate dewatering and drying are used at larger plants with such dewatering methods including but not limited to the following: vacuum filtration, filter pressing and centrifugation, and such drying methods including but not limited to the following: drying beds, rotary drums, fluidized bed dryers, and dryers with opposite jets. Sludge is sometimes thickened, dewatered and dried without biological stabilization or prior to stabilization processes such as but not limited to in-vessel or aerated pile composting.

### SUMMARY OF THE INVENTION

In the present invention, precipitation-generated wastewater influent and plain or conditioned anaerobic or aerobic sludge are first fed upstream of, or directly into an anaerobic reactor so as to cause the precipitation-generated wastewater influent and the plain or conditioned anaerobic or aerobic sludge to become well mixed “mixed liquor.” The reactor effects removal of dissolved and suspended pollutants from the precipitation-generated wastewater and at least partial transformation of constituents of concern. Next, the mixed liquor is aerated in the reactor to establish aerobic conditions in the mixed liquor. Once aerobic conditions in the mixed liquor are established, the mixed liquor is subjected to solids/liquid separation. A further transformation of constituents of concern can be expected to occur as a byproduct of establishing aerobic conditions in the mixed liquor.

In the present invention as in other wastewater treatment processes for wet streams, both effluent and sludge results from solids/liquid separation. The effluent is the separated liquid. Effluent may be discharged for further treatment, may be discharged directly to the environment or may be combined with the effluent from the main plant processes and then discharged to the environment. The sludge is the separated solids consisting of the biological and other solids as described above. Sludge may be recycled to the anaerobic reactor to provide some or all of the solids needed by the anaerobic subsystem. If the sludge exceeds the amount needed to be recycled to the anaerobic subsystem, sludge may then be either directed to the main wet stream processes of the wastewater treatment plant or directed to the solids stream of the plant. However, the balance of all sludge, equal to the sludge growth amount by the main wet stream processes of the plant and the present invention, is eventually discharged to the solids stream of the plant as is the case when the plant is processing wastewater collected and transported by the centralized system during dry weather conditions.

In the present invention, the sludge conditioning may include anaerobic conditioning, a combination of aerobic and anaerobic conditioning steps, chemical conditioning, and a combination of chemical and biological conditioning steps including aerobic and anaerobic steps and combinations thereof.

### BRIEF DESCRIPTION OF THE DRAWINGS

FIG. 1 is a schematic diagram of the preferred process of the present invention.

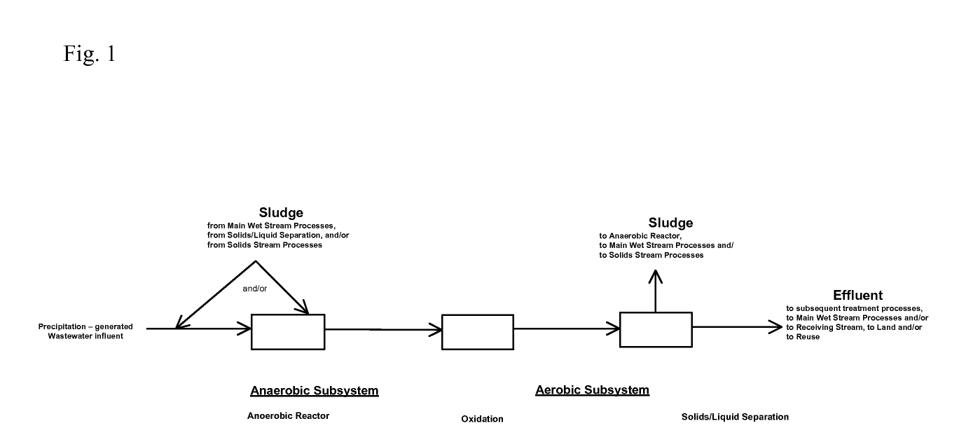

### DETAILED DESCRIPTION OF THE INVENTION

The present invention relates to the application of the biological adsorption and biological oxidation ability of both conventional wastewater treatment biological selection technology and, if desired, chemically-enhanced wastewater treatment biological selection technology to remove pollutants from precipitation-generated flows collected by a combined sanitary sewer system, a separate sanitary sewer system, and/or a combination of both systems for: (1) the biological adsorption and oxidation of suspended and dissolved pollutants as measured by standard methods tests for carbonaceous biochemical oxygen demand, and/or (2) the biological adsorption of all other dissolved non-conservative and conservative pollutants as measured by all other standard methods tests for such pollutants.

Thus, the present invention is directed to a method for intermittent wastewater processing in a new process element of a preexisting wastewater treatment plant, which comprises: (a) feeding wastewater and influent sewage and activated sludge solids from the wastewater treatment plant into an anaerobic reactor during rainfall-induced, high combined sewerage flows (e.g., sanitary or storm water flows), so as to cause the sewage and sludge solids to become a mixed liquor; (b) mixing the mixed liquor in the anaerobic reactor (for e.g., about 15-50 minutes) and returning the mixed liquor to the biological treatment and subsequent mixed liquor separation processes in the preexisting plant; and (c) subjecting the mixed liquor to solids/liquids separation, wherein aerobic conditions are established in the mixed liquor prior to separation, with the separated sludge solids recycled to the anaerobic reactor or discharged to a solids stream in the wastewater treatment plant.

Alternatively, the present invention relates to a method for intermittent wastewater processing in a wastewater treatment plant during rainfall-induced, high combined sewerage flows, which comprises: (a) feeding wastewater and influent liquids and sludge solids into an anaerobic reactor, so as to cause the liquids and sludge solids to become a mixed liquor; (b) aerating the mixed liquor in the reactor after anaerobic processing of the combined rainfall-induced sewerage; and (c) subjecting the entire mixed liquor to solids/liquids separation in a clarifier of the wastewater treatment plant.

The system of the present invention uses coupled anaerobic-aerobic suspended growth biological treatment in either an open or closed reactor to adsorb/absorb dissolved organics, suspended materials and dissolved inorganics contained in precipitation-generated wastewater flows collected and/or transported to a wastewater treatment site resulting from the implementation of combined sewer overflow (CSO) control projects and/or separate sewer overflow (SSO) control projects, rather than discharge the pollutants to the environment at the plant or at one or more CSO and/or SSO discharge points located in the centralized system of pipes and channels.

In the system of the present invention, the following advantageous outcomes are achieved: (a) precipitation-generated wastewater flow and sludge are mixed upstream of an anaerobic reactor, upon entering an anaerobic reactor or are mixed after entering an anaerobic reactor; (b) dissolved organic, dissolved inorganic and dissolved metal pollutants in the precipitation-generated wastewater flow are absorbed into the sludge contained in the mixed liquor in the anaerobic reactor; (c) the anaerobic mixed liquor after anaerobic treatment is aerated to jointly provide partial aerobic treatment and to allow aerobic solids/liquid separation; (d) the aerobic solids/liquid separation may occur in a separate subsystem or alternatively in existing units after combination with the contents or effluents of the main wet stream process of the plant; and (e) the separated solids after solids/liquid separation are recycled to the anaerobic reactor, directed to the main wet stream processes of the plant or directed to the solids stream processes of the plant.

In one embodiment of the present invention, based on predetermined rainfall rates and sewer depth of flow, the process fill sequence is triggered at predetermined locations in the collection system. Into an empty reactor is entered either separate flow streams of precipitation-generated wastewater influent and of sludge or a single flow stream of both solids and precipitation-generated wastewater influent. The Mixed Liquor Suspended Solids flow, loading rate and hydraulic regime is controlled so as to provide general mixing and an adsorption time of from about 15 to 90 minutes, while additional flow is directed to another, identical reactor. The total number of reactors is dependent on flows and the desired modular redundancy. After the reactor adsorption is completed, the liquor is oxygenated in a conveyance to the solids/liquid separation subsystem. The solids/liquid separation may occur in a separate subsystem, or alternatively in existing units after combination with the main process Mixed Liquor Aeration Basin contents or effluents. Alternatively, if separate clarification is used, the resulting liquid may be discharged for further treatment, to the environment or for combination with main process effluent for discharge. The resulting solids may be directed to mixing with the precipitation-generated wastewater influent before or in the reactor of the present invention or to solids treatment processes, or partially to both.

After treatment in accordance with the present invention, the separated aerobic liquid solids/liquid separation may be discharged directly to the environment and either discharged to subsequent treatment and then blended with effluent from the main plant process or discharged directly to the environment, any of which result in an effluent that has received substantial biological treatment of the precipitation-generated wastewater collected and transported by the centralized system of pipes and channels.

The process characteristics of the system of the present invention are as follows:

| Process Characteristics | Range |
|---|---|
| pH | 6.5-9.5 |
| temperature (° C.) | 6-35 |
| Dissolved Oxygen in reactor (mg/L) | <0.8 at all times |
| Mixed liquor suspended solids (mg/L) | 200-8,500 |
| Mixing retention time (min.) | 15-90 |
| Dissolved Oxygen after aeration (mg/L) | >3.0 at all times |

In a further embodiment, the present invention constitutes a new application of anaerobic biological adsorption in an intermittent process that occurs only during wet weather events. In anticipation of large rainfall-induced combined storm/sanitary sewage flows, biomass and combined sewage are mixed together for a period of time, usually up to about three days only during a rainfall event. The goal is to achieve the adsorption of pollutants anaerobically in biological treatment, which otherwise may be released into the environment as untreated overflows. After such anaerobic treatment, the biomass is briefly aerated with atmospheric air, so as to permit better biomass separation performance in existing clarifiers.

While the present invention has been described with respect to particular embodiments thereof, it is apparent that numerous other forms and modifications of the invention will be obvious to those skilled in the art. The appended claims and the present invention generally should be construed to cover all such obvious forms and modifications which are within the true spirit and scope of the present invention.

What is claimed is:

1. A method for intermittent wastewater processing in a wastewater treatment plant, which comprises:
(a) feeding wastewater and influent sewage and activated sludge solids from the wastewater treatment plant into an anaerobic reactor during rainfall-induced, high combined sewerage flows, so as to cause the sewage and sludge solids to become a mixed liquor;
(b) mixing the mixed liquor in the anaerobic reactor and returning the mixed liquor to the biological treatment and subsequent mixed liquor separation processes in the preexisting wastewater treatment plant; and
(c) subjecting the mixed liquor to solids/liquids separation, wherein aerobic conditions are established in the mixed liquor prior to separation, with the separated sludge solids recycled to the anaerobic reactor or discharged to a solids stream in the wastewater treatment plant.

2. The method as recited in claim 1, wherein said sludge is plain or conditioned.

3. The method as recited in claim 1, wherein said sludge is anaerobic or aerobic.

5. The method as recited in claim 1, wherein said sludge is fed upstream of the anaerobic reactor.

6. The method as recited in claim 1, wherein said sludge is fed directly into the anaerobic reactor.

7. The method as recited in claim 1, wherein the sewerage flows are sanitary or storm water flows.

8. The method as recited in claim 1, wherein the mixed liquor is mixed in the anaerobic reactor for about 15-50 minutes.

9. A method for intermittent wastewater processing in a wastewater treatment plant during rainfall-induced, high combined sewerage flows, which comprises:
(a) feeding wastewater and influent liquids and sludge solids into an anaerobic reactor, so as to cause the liquids and sludge solids to become a mixed liquor;
(b) aerating the mixed liquor in the reactor after anaerobic processing of the combined rainfall-induced sewerage; and
(c) subjecting the entire mixed liquor to solids/liquids separation in a clarifier of the wastewater treatment plant.

10. The method as recited in claim 9, wherein said sludge is plain or conditioned.

11. The method as recited in claim 9, wherein said sludge is anaerobic or aerobic.

12. The method as recited in claim 9, wherein the sewerage flows are sanitary or storm water flows.

13. The method as recited in claim 9, wherein the mixed liquor is mixed in the anaerobic reactor for about 15-50 minutes.
